(19) United States
(12) Patent Application Publication
(10) Pub. No.: US 2024/0342605 A1
(43) Pub. Date: Oct. 17, 2024

(54) VIRTUAL OBJECT CONTROL METHOD AND APPARATUS, DEVICE, AND STORAGE MEDIUM

(71) Applicant: Tencent Technology (Shenzhen) Company Limited, Shenzhen (CN)

(72) Inventor: Zhuocheng ZOU, Shenzhen (CN)

(21) Appl. No.: 18/751,120

(22) Filed: Jun. 21, 2024

Related U.S. Application Data
(63) Continuation of application No. PCT/CN2023/084729, filed on Mar. 29, 2023.

(30) Foreign Application Priority Data
May 31, 2022 (CN) 202210611053.1

(51) Int. Cl. A63F 13/56; A63F 13/42; A63F 13/533; A63F 13/58; A63F 13/833

(52) U.S. Cl. CPC A63F 13/56; A63F 13/42; A63F 13/533; A63F 13/58; A63F 13/833

(57) ABSTRACT

A virtual object control method is performed by a computer device. The method includes: displaying first and second virtual objects in a virtual scene; in response to a trigger operation on a mirror interaction control associated with the first virtual object, controlling the first virtual object to move in a first direction, and displaying a mirror virtual object of the first virtual object at a first location in the virtual scene; during the movement of the first virtual object in the first direction, controlling the first virtual object to move to the first location in response to a trigger operation on the mirror interaction control; controlling the first and second virtual objects to jointly move to the first location when they come into contact; and controlling the first virtual object to perform interaction with the second virtual object after the first virtual object and the mirror virtual object overlap.

### CROSS-REFERENCE TO RELATED APPLICATIONS

This application is a continuation application of PCT Patent Application No. PCT/CN2023/084729, entitled “VIRTUAL OBJECT CONTROL METHOD AND APPARATUS, DEVICE, AND STORAGE MEDIUM” filed on Mar. 29, 2023, which claims priority to Chinese Patent Application No. 202210611053.1, entitled “VIRTUAL OBJECT CONTROL METHOD AND APPARATUS, DEVICE, AND STORAGE MEDIUM” filed on May 31, 2022, both of which are incorporated by reference in their entirety.

### FIELD OF THE TECHNOLOGY

This application relates to the field of computer technologies, and in particular, to a virtual object control method and apparatus, a device, and a storage medium.

### BACKGROUND OF THE DISCLOSURE

With the development of multimedia technologies and the diversification of functions of terminals, there are an increasing number of games that can be played on the terminals. A fighting game is a relatively prevalent game. The fighting game provides a virtual scene for users, and two users respectively control two virtual objects to fight in the virtual scene.

In the related art, a user often controls a virtual object to fight by using fists and feet. To be specific, during fighting, the user can control the virtual object to attack another virtual object by only using the fists or the feet alone, or using a combination of the fists and the feet.

However, in the related art, the user controls the virtual object to fight in a single form, and the user cannot control the virtual object to complete effective interaction with another virtual object, resulting in low efficiency of human-computer interaction and poor game experience for the user.

### SUMMARY

Embodiments of this application provide a virtual object control method and apparatus, a device, and a storage medium, which can improve efficiency of human-computer interaction. The technical solutions are as follows:

According to an aspect, a virtual object control method is performed by a computer device, the method including:

displaying a first virtual object and a second virtual object in a virtual scene, the second virtual object and the first virtual object belonging to different camps;

in response to a first trigger operation on a mirror interaction control associated with the first virtual object, controlling the first virtual object to move in a first direction, and displaying a mirror virtual object of the first virtual object at a first location in the virtual scene based on, but different from, a contact location at which the first virtual object comes into contact with the second virtual object;

during the movement of the first virtual object in the first direction, controlling the first virtual object to move to the first location in response to a second trigger operation on the mirror interaction control;

controlling the first virtual object and the second virtual object to jointly move to the first location after the first virtual object comes into contact with the second virtual object; and

controlling the first virtual object to perform interaction with the second virtual object after the first virtual object and the mirror virtual object overlap.

According to an aspect, a computer device is provided, including one or more processors and one or more memories, the one or more memories having at least one computer program stored therein, the at least one computer program, when executed by the one or more processors, causing the computer device to implement the virtual object control method.

According to an aspect, a non-transitory computer-readable storage medium is provided, having at least one computer program stored therein, the computer program, when executed by a processor of a computer device, causing the computer device to implement the virtual object control method.

Through the technical solutions provided in the embodiments of this application, a first virtual object and a second virtual object are displayed in a virtual scene, and a mirror interaction control can be triggered to control the first virtual object to move in a first direction, and display a mirror virtual object of the first virtual object in the virtual scene; during the movement of the first virtual object, the first virtual object is controlled to move to a location of the mirror virtual object in response to a trigger operation on the mirror interaction control again; the first virtual object and the second virtual object are controlled to jointly move to the location of the mirror virtual object when the first virtual object comes into contact with the second virtual object; and the first virtual object is controlled to perform interaction with the second virtual object when the first virtual object and the mirror virtual object overlap. Through the setting of the mirror virtual object, a manner of interaction between the first virtual object and the second virtual object is enriched, so that a user can effectively perform interaction with the second virtual object by using the mirror virtual object, thereby improving efficiency of human-computer interaction.

### BRIEF DESCRIPTION OF THE DRAWINGS

FIG. 1 is a schematic diagram of an implementation environment of a virtual object control method according to an embodiment of this application.

FIG. 2 is a flowchart of a virtual object control method according to an embodiment of this application.

FIG. 3 is a flowchart of another virtual object control method according to an embodiment of this application.

FIG. 4 is a schematic diagram of a virtual scene according to an embodiment of this application.

FIG. 5 is a schematic diagram of another virtual scene according to an embodiment of this application.

FIG. 6 is a schematic diagram of still another virtual scene according to an embodiment of this application.

FIG. 7 is a schematic diagram of yet another virtual scene according to an embodiment of this application.

FIG. 8 is a schematic diagram of yet another virtual scene according to an embodiment of this application.

FIG. 9 is a flowchart of still another virtual object control method according to an embodiment of this application.

FIG. 10 is a schematic structural diagram of a virtual object control apparatus according to an embodiment of this application.

FIG. 11 is a schematic structural diagram of a terminal according to an embodiment of this application.

FIG. 12 is a schematic structural diagram of a server according to an embodiment of this application.

### DESCRIPTION OF EMBODIMENTS

To make objectives, technical solutions, and advantages of this application clearer, the following further describes in detail implementations of this application with reference to accompanying drawings.

The terms “first”, “second”, and the like in this application are used for distinguishing between same items or similar items of which effects and functions are basically the same. The “first”, “second”, and “n^{th}” do not have a dependency relationship in logic or time sequence, and a quantity and an execution sequence thereof are not limited.

Virtual scene: A virtual scene is displayed (or provided) when an application program is run on a terminal. The virtual scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene, and the dimension of the virtual scene is not limited in the embodiments of this application. For example, the virtual scene may include the sky, the land, the ocean, and the like. The land may include environmental elements such as the desert and a city. A user may control a virtual object to move in the virtual scene. In a fighting game, a virtual scene is also referred to as a virtual fighting scene.

Virtual object: It is a movable object in a virtual scene. The movable object may be a virtual character, a virtual animal, a cartoon character, or the like, for example, a character, an animal, a plant, an oil drum, a wall, or a stone displayed in the virtual scene. The virtual object may be a virtual image configured for representing a user in the virtual scene. The virtual scene may include a plurality of virtual objects, and each virtual object has a shape and a volume in the virtual scene, and occupies some space in the virtual scene.

In one embodiment, the virtual object is a user character controlled through an operation on a client, or an artificial intelligence (AI) character set in a virtual scene battle through training, or a non-player character (NPC) set in the virtual scene. In one embodiment, the virtual object is a virtual character competing in the virtual scene. In one embodiment, a quantity of virtual objects participating in interaction in the virtual scene is preset, or is dynamically determined according to a quantity of clients participating in the interaction.

Information (including but not limited to user device information, user personal information, and the like), data (including but not limited to data for analysis, stored data, displayed data, and the like) and signals involved in this application are authorized by a user or fully authorized by all parties, and collection, use, and processing of relevant data need to comply with relevant laws, regulations, and standards of relevant countries and regions.

An implementation environment of the technical solutions provided in the embodiments of this application are described below.

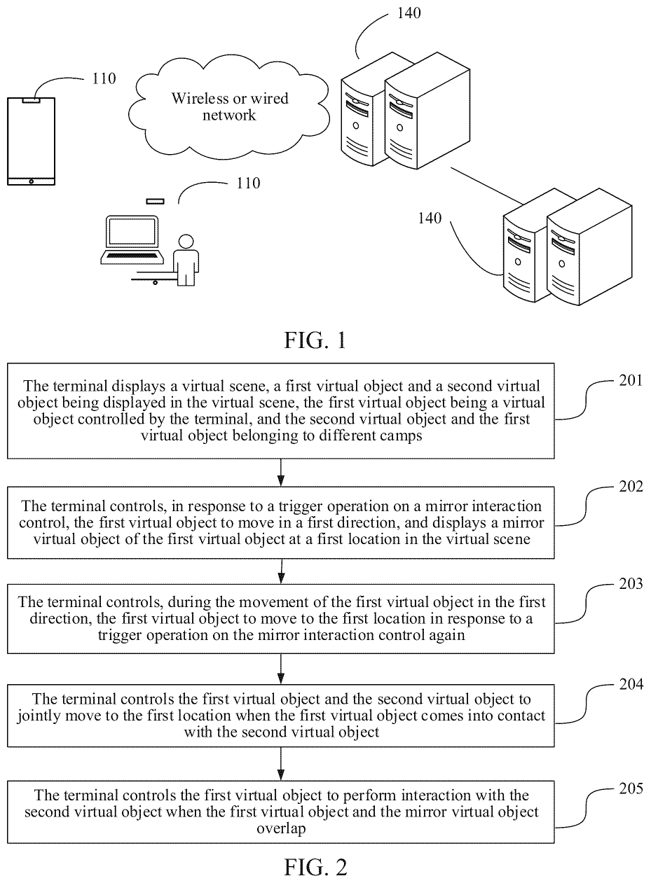

FIG. 1 is a schematic diagram of an implementation environment of a virtual object control method according to an embodiment of this application. Referring to FIG. 1, the implementation environment may include a terminal 110 and a server 140.

The terminal 110 is connected to the server 140 by using a wireless network or a wired network. In one embodiment, the terminal 110 may be a smartphone, a tablet computer, a notebook computer, a desktop computer, a smartwatch, or the like, but is not limited thereto. An application program supporting in displaying a virtual scene is installed and run on the terminal 110.

The server 140 is an independent physical server, or is a server cluster or a distributed system formed by a plurality of physical servers, or is a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The server 140 provides a back-end service to application programs run in the terminal 110.

In one embodiment, there may be a plurality of terminals 110 and servers 140.

After the implementation environment of the embodiments of this application is described, an application scenario of the embodiments of this application is described below. In the following descriptions, a terminal is the terminal 110 in the foregoing implementation environment, and a server is the foregoing server 140.

The technical solutions provided in the embodiments of this application can be applied to a fighting game. In the fighting game, a terminal displays a virtual scene, the terminal controls a first virtual object in the virtual scene, and the first virtual object and a second virtual object fight in the virtual scene. The terminal can control the first virtual object to directly attack the second virtual object by using fists and feet or a virtual prop in the virtual scene, or can control the first virtual object to attack the second virtual object by casting a virtual skill in the virtual scene. Both the first virtual object and the second virtual object have health values in the virtual scene. When a health value of any virtual object is 0, the virtual object is defeated by an opponent. When the virtual object is attacked and hit, the health value of the virtual object decreases. The being attacked herein includes being directly attacked by fists and feet or a virtual prop, and also being attacked by a virtual skill. When a mirror interaction control displayed by the terminal is triggered, the terminal displays a mirror virtual object of the first virtual object in the virtual scene. The mirror interaction control, also referred to as a skill control, can control the first virtual object to cast a virtual skill in the virtual scene. The terminal may control the mirror virtual object to perform interaction with the second virtual object, that is, control the mirror virtual object to launch an attack to the second virtual object.

Rendering of the virtual scene may be completed by the terminal or the server. This is not limited in the embodiments of this application.

After the implementation environment and the application scenario of the embodiments of this application are described, the virtual object control method provided in the embodiments of this application is described below. In the following process of describing the technical solutions provided in this application, an example in which a terminal is used as an execution entity is used. In other possible implementations, the technical solutions provided in this application may alternatively be jointly performed by a terminal and a server. A type of the execution entity is not limited in the embodiments of this application. Referring to FIG. 2, by using an example in which an execution entity is a terminal, the method includes the following operations.

201: The terminal displays a virtual scene, a first virtual object and a second virtual object being displayed in the virtual scene, the first virtual object being a virtual object controlled by the terminal, and the second virtual object and the first virtual object belonging to different camps.

The virtual scene is also referred to as a virtual fighting scene. In a possible implementation, the virtual scene has four boundaries: an upper boundary, a lower boundary, a left boundary, and a right boundary. A virtual object in the virtual scene is free to move within a range of the four boundaries. The first virtual object is the virtual object controlled by the terminal, and the second virtual object is a virtual object controlled by another terminal or a virtual object controlled by AI. This is not limited in the embodiments of this application. That the second virtual object and the first virtual object belong to different camps means that an opponent relationship exists between the second virtual object and the first virtual object in the virtual scene, and the first virtual object and the second virtual object can perform interaction in the virtual scene, that is, attack each other in the virtual scene.

202: The terminal controls, in response to a trigger operation on a mirror interaction control, the first virtual object to move in a first direction, and displays a mirror virtual object of the first virtual object at a first location in the virtual scene.

The terminal displays the mirror interaction control, where the mirror interaction control is a skill control of the first virtual object, and the mirror interaction control can be triggered to control the first virtual object to cast a virtual skill in the virtual scene. A display location of the mirror interaction control is set by a technician or a user according to an actual case. This is not limited in the embodiments of this application.

The first direction is set by the technician according to an actual case. For example, the first direction is set to a facing direction of the first virtual object, or an upward direction of the first virtual object, or a back direction of the first virtual object. This is not limited in the embodiments of this application.

The first location is set by the technician according to an actual case. For example, the first location is a location across from the first virtual object, and a distance between the first location and the first virtual object is a preset distance. For another example, the first location is related to a contact location, and the contact location is a location at which the first virtual object comes into contact with the second virtual object, for example, a distance between the first location and the contact location is a preset distance. For another example, the first location is a location of the first virtual object. For another example, the first location is a preset location in the virtual scene. This is not limited in the embodiments of this application.

The mirror virtual object of the first virtual object is a clone of the first virtual object. The mirror virtual object has the same external shape as the first virtual object.

203: The terminal controls, during the movement of the first virtual object in the first direction, the first virtual object to move to the first location in response to a trigger operation on the mirror interaction control again.

The mirror interaction control has two layers of functions: The first-layer function is to control the first virtual object to move in the first direction; and the second-layer function is to control the first virtual object to move to a location of the mirror virtual object. The second-layer function can be triggered only based on the implementation of the first-layer function.

204: The terminal controls the first virtual object and the second virtual object to jointly move to the first location when the first virtual object comes into contact with the second virtual object.

That the first virtual object comes into contact with the second virtual object means that a model of the first virtual object comes into contact with a model of the second virtual object. That the first virtual object and the second virtual object jointly move to the first location means that the second virtual object is “brought” by the first virtual object to the location of the mirror virtual object.

205: The terminal controls the first virtual object to perform interaction with the second virtual object when the first virtual object and the mirror virtual object overlap.

That the first virtual object is controlled to perform interaction with the second virtual object means that the first virtual object is controlled to actively perform interaction with the second virtual object, for example, the first virtual object is controlled to attack the second virtual object.

In a possible implementation, the terminal controls the first virtual object to perform interaction with the second virtual object when the first virtual object and the mirror virtual object overlap and a distance between the second virtual object and the mirror virtual object meets a first distance condition.

That the distance between the second virtual object and the mirror virtual object meets the first distance condition means that the distance between the second virtual object and the mirror virtual object is less than or equal to a first distance threshold. The first distance threshold is set by the technician according to an actual case, for example, the first distance threshold is set to two body locations, three body locations, or the like. This is not limited in the embodiments of this application.

Through the technical solutions provided in the embodiments of this application, a first virtual object and a second virtual object are displayed in a virtual scene, and a mirror interaction control can be triggered to control the first virtual object to move in a first direction, and display a mirror virtual object of the first virtual object in the virtual scene; during the movement of the first virtual object, the first virtual object is controlled to move to a location of the mirror virtual object in response to a trigger operation on the mirror interaction control again; the first virtual object and the second virtual object are controlled to jointly move to the location of the mirror virtual object when the first virtual object comes into contact with the second virtual object; and the first virtual object is controlled to perform interaction with the second virtual object when the first virtual object and the mirror virtual object overlap. Through the setting of the mirror virtual object, a manner of interaction between the first virtual object and the second virtual object is enriched, so that a user can effectively perform interaction with the second virtual object by using the mirror virtual object, thereby improving efficiency of human-computer interaction.

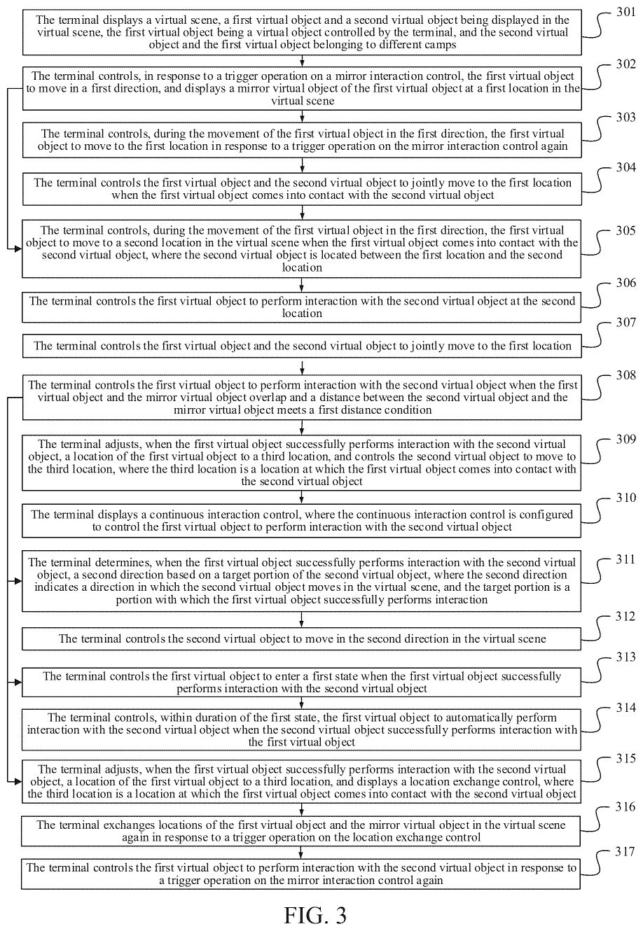

The foregoing operations 201 to 205 are simple descriptions of the virtual object control method provided in the embodiments of this application. The following describes the virtual object control method provided in the embodiments of this application more clearly with reference to some examples. Referring to FIG. 3, by using an example in which an execution entity is a terminal, the method includes the following operations.

301: The terminal displays a virtual scene, a first virtual object and a second virtual object being displayed in the virtual scene, the first virtual object being a virtual object controlled by the terminal, and the second virtual object and the first virtual object belonging to different camps.

The virtual scene is also referred to as a virtual fighting scene, and the virtual fighting scene is a background of a fighting game. The virtual objects can fight in the virtual scene. Fighting is an interactive behavior between two virtual objects, and the two virtual objects can fight by using fists and foot, using a virtual prop, casting a virtual skill, and the like.

That the second virtual object and the first virtual object belong to different camps means that an opponent relationship exists between the second virtual object and the first virtual object in the virtual scene, and the first virtual object and the second virtual object can perform interaction in the virtual scene, that is, fight in the virtual scene. In the virtual scene, the first virtual object and the second virtual object each have an initial health value with a specified quantity. During interaction between the first virtual object and the second virtual object, the health values of the first virtual object and the second virtual object continuously decrease. The initial health value of the first virtual object may be the same as that of the second virtual object or may be different from that of the second virtual object. This is not limited in the embodiments of this application. When a health value of any virtual object decreases to a target value, for example, 0, the virtual object is defeated by another virtual object. The health value is also referred to as a hit point, a heath point, or the like. The first virtual object is selected by a user before the virtual scene is loaded.

In a possible implementation, in the virtual scene, the first virtual object is always toward the second virtual object, and the second virtual object is always toward the first virtual object. In other words, when relative locations of the first virtual object and the second virtual object change, the first virtual object and the second virtual object are always toward each other. Certainly, the facing directions of the first virtual object and the second virtual object do not change when interaction is performed, and are automatically adjusted when the interaction ends.

In a possible implementation, in response to that a user starts an arena battle, the terminal displays a virtual scene of the arena battle, where the first virtual object and the second virtual object are displayed in the virtual scene, and the first virtual object and the second virtual object are displayed on two sides of the virtual scene. An arena battle is a fighting game, and the virtual scene displayed by the terminal may be a complete virtual scene or a part of a virtual scene. When the virtual scene displayed by the terminal is a part of the virtual scene, the virtual scene displayed by the terminal is moved with the first virtual object. For example, the first virtual object is always displayed on a left side of the virtual scene.

In a possible implementation, the terminal further displays a plurality of controls, where the plurality of controls are configured to control actions of the first virtual object in the virtual scene, and the user can control the first virtual object by taping or dragging the plurality of controls. For example, the plurality of controls may be divided into movement-type controls and interaction-type controls. The movement-type controls are configured to control movement of the first virtual object in the virtual scene, for example, the movement-type controls are configured to control the first virtual object to move left, move right, squat, take off, and the like in the virtual scene. The interaction-type controls are configured to control the first virtual object to use a virtual skill, attack an enemy, catch an enemy, and the like in the virtual scene.

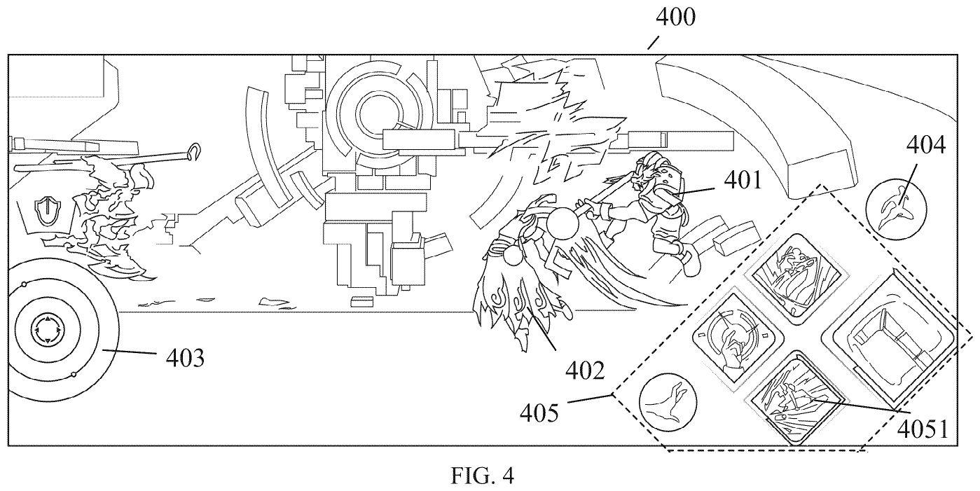

For example, referring to FIG. 4, the terminal displays a virtual scene 400, where a first virtual object 401 and a second virtual object 402 are displayed in the virtual scene. The terminal further displays a movement-type control 403, a movement-type control 404, and an interaction type control 405. In a possible implementation, the user can drag the movement-type control 403 to control the first virtual object 401 to move in the virtual scene 400, and can tap the movement-type control 404 to control the first virtual object 401 to jump in the virtual scene 400.

302: The terminal controls, in response to a trigger operation on a mirror interaction control, the first virtual object to move in a first direction, and displays a mirror virtual object of the first virtual object at a first location in the virtual scene.

The terminal displays the mirror interaction control, where the mirror interaction control is a skill control of the first virtual object, the mirror interaction control belongs to the foregoing interaction-type controls, and the mirror interaction control can be triggered to control the first virtual object to cast a virtual skill in the virtual scene. A display location of the mirror interaction control is set by a technician or the user according to an actual case. This is not limited in the embodiments of this application. The first direction is set by the technician according to an actual case. For example, the first direction is set to a facing direction of the first virtual object, or an upward direction of the first virtual object, or a back direction of the first virtual object. This is not limited in the embodiments of this application. The first location is a location of the first virtual object when the mirror interaction control is triggered, or another location in the virtual scene. This is not limited in the embodiments of this application.

The following first describes the method in which the terminal controls the first virtual object to move in the first direction in response to the trigger operation on the mirror interaction control.

In a possible implementation, the terminal controls the first virtual object to move in the first direction in response to a tap operation on the mirror interaction control. When the mirror interaction control is the skill control of the first virtual object, that the mirror interaction control is taped means that the first virtual object is controlled to cast a corresponding virtual skill in the virtual scene. One of effects of the virtual skill is that the first virtual object moves in the first direction. For example, referring to FIG. 4, the terminal controls the first virtual object 401 to move in a first direction in response to a tap operation on a mirror interaction control 4051.

The tap operation described in the foregoing implementation includes an operation of taping a touch screen, and further includes a click operation by using an external device such as a mouse. This is not limited in the embodiments of this application.

By using an example in which the first direction is a facing direction of the first virtual object, the terminal controls the first virtual object to move in the facing direction in response to the tap operation on the mirror interaction control. When the first virtual object moves in the facing direction, movement forms include running, fluttering, kicking, and the like. This is not limited in the embodiments of this application.

In a possible implementation, a distance that the first virtual object moves by in the first direction is a target distance, that is, a distance that the first virtual object automatically moves by after the mirror interaction control is taped is the target distance. When the distance that the first virtual object automatically moves by reaches the target distance, the first virtual object stops moving. The target distance is set by the technician according to an actual case. This is not limited in the embodiments of this application.

The following describes the method in which the terminal displays the mirror virtual object of the first virtual object at the first location in the virtual scene in response to the trigger operation on the mirror interaction control.

The mirror virtual object of the first virtual object is a clone of the first virtual object. The mirror virtual object has the same external shape as the first virtual object. For example, if the first virtual object holds a virtual prop, the mirror virtual object also holds the same virtual prop. In a possible implementation, transparency of the mirror virtual object is different from that of the first virtual object, so that the user can quickly resolve the mirror virtual object and the first virtual object through the transparency, and the efficiency of human-computer interaction is high. After the terminal displays the mirror virtual object of the first virtual object at the first location, a location of the mirror virtual object is fixed at the first location, that is, the location of the mirror virtual object does not change. In a possible implementation, the mirror virtual object is also referred to as a clone of the first virtual object. In this case, the first virtual object may also be referred to as a body.

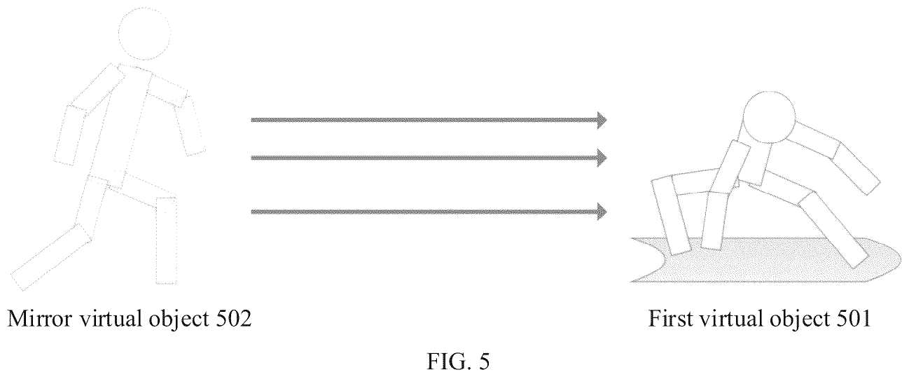

In a possible implementation, in response to the trigger operation on the mirror interaction control, the terminal loads a model of the mirror virtual object, and renders the model of the mirror virtual object at the first location, to display the mirror virtual object at the first location. For example, referring to FIG. 5, a first virtual object 501 moves in a facing direction, and a mirror virtual object 502 is generated in place.

In a possible implementation, when the terminal displays the mirror virtual object at the first location, the terminal may directly display the mirror virtual object or gradually display the mirror virtual object. This is not limited in the embodiments of this application.

In a possible implementation, in addition to being able to directly display the mirror virtual object of the first virtual object after the mirror interaction control is triggered, the terminal can also display the mirror virtual object of the first virtual object after the first virtual object comes into contact with the second virtual object. This is not limited in the embodiments of this application.

After operation 302, the terminal may perform the following operations 303 and 304, or may perform the following operations 305 to 307. This is not limited in the embodiments of this application.

303: The terminal controls, during the movement of the first virtual object in the first direction, the first virtual object to move to the first location in response to a trigger operation on the mirror interaction control again.

In a possible implementation, the terminal controls, during the movement of the first virtual object in the first direction, the first virtual object to move to the first location in response to a tap operation on the mirror interaction control again. That the first virtual object moves to the first location means that the first virtual object moves to the mirror virtual object of the first virtual object.

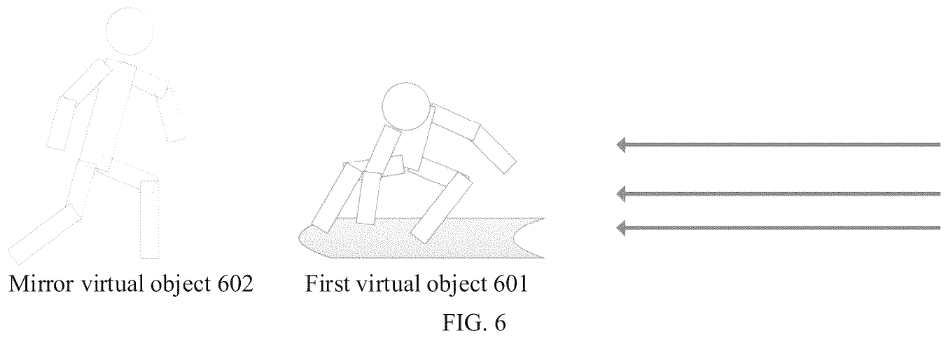

For example, referring to FIG. 6, during the movement of the first virtual object in the first direction, in response to the tap operation on the mirror interaction control again, the terminal controls a first virtual object 601 to move to the first location, that is, controls the first virtual object 601 to move to a location of the mirror virtual object 602.

In a possible implementation, the terminal controls, during the movement of the first virtual object in the first direction, the first virtual object to continuously move in the first direction after the first virtual object comes into contact with the second virtual object for the first time. The terminal controls the second virtual object to be maintained at a current location. The terminal controls the first virtual object to move to the first location in response to the tap operation on the mirror interaction control again.

That the first virtual object comes into contact with the second virtual object means that a model of the first virtual object comes into contact with a model of the second virtual object. In a possible implementation, invisible collision detection boxes are bound to the model of the first virtual object and the model of the second virtual object, and the terminal can determine, through the collision detection boxes, whether the model of the first virtual object comes into contact with the model of the second virtual object. In a possible implementation, that the first virtual object comes into contact with the second virtual object indicates that the virtual skill triggered by the mirror interaction control takes effect. In a possible implementation, that the first virtual object comes into contact with the second virtual object is a form of interaction between the first virtual object and the second virtual object, or a form in which the first virtual object attacks the second virtual object in the virtual scene. When the first virtual object comes into contact with the second virtual object, a health value of the second virtual object decreases. The mirror interaction control is configured to control the first virtual object to move to the first location.

From a perspective of the user, after the first virtual object comes into contact with the second virtual object, the first virtual object continuously moves “across” the second virtual object, and the second virtual object is “jailed” in place. In a possible implementation, duration for which the terminal controls the second virtual object to be maintained at the current location is first duration. The first duration is set by the technician according to an actual case. This is not limited in the embodiments of this application.

In a possible implementation, the terminal cancels the displaying of the mirror virtual object when a trigger operation performed on the mirror interaction control is not detected within target duration.

304: The terminal controls the first virtual object and the second virtual object to jointly move to the first location when the first virtual object comes into contact with the second virtual object.

That the second virtual object and the first virtual object are controlled to jointly move to the first location means that the second virtual object and the first virtual object are controlled to move to the first location with the same speed and direction. In other words, during the joint movement of the second virtual object and the first virtual object to the first location, the second virtual object and the first virtual object are in an overlapping state.

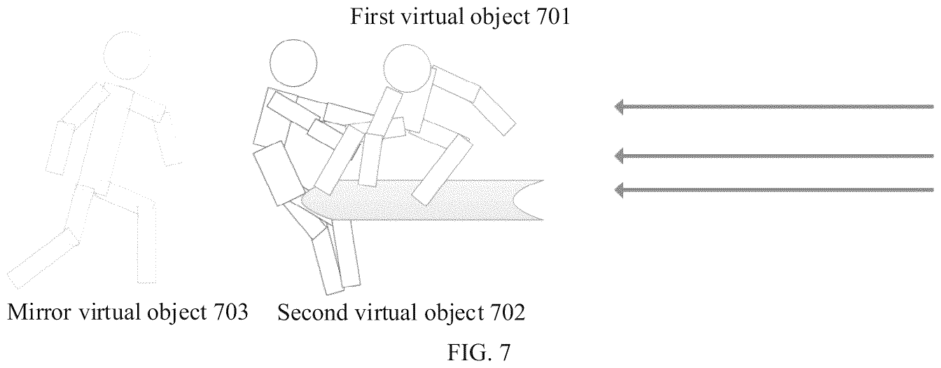

During the movement of the first virtual object to the first location, the first virtual object may come into contact with the second virtual object or may not come into contact with the second virtual object. This is because an occasion at which the first virtual object moves to the first location depends on a secondary trigger occasion of the mirror interaction control. When the secondary trigger occasion of the mirror interaction control is a correct occasion, the first virtual object can come into contact with the second virtual object again when the first virtual object moves to the first location. When the secondary trigger occasion of the mirror interaction control is an error occasion, the first virtual object cannot come into contact with the second virtual object again when the first virtual object moves to the first location. The correct occasion and the error occasion are set by the technician according to an actual case. This is not limited in the embodiments of this application. For example, referring to FIG. 7, when a first virtual object 701 comes into contact with a second virtual object 702, the first virtual object 701 and the second virtual object 702 are controlled to jointly move to the first location, that is, the first virtual object 701 and the second virtual object 702 are controlled to jointly move to a location of a mirror virtual object 703.

In a possible implementation, the terminal displays a movement control when the first virtual object comes into contact with the second virtual object, where the movement control is configured to control the first virtual object to move to the first location. The terminal controls the first virtual object and the second virtual object to jointly move to the first location in response to a trigger operation on the mirror interaction control.

In a possible implementation, the terminal determines, during the movement of the first virtual object to the first location, a status of the second virtual object when the first virtual object comes into contact with the second virtual object. The terminal controls the first virtual object and the second virtual object to jointly move to the first location when the second virtual object is not in a second state. The second state is also referred to as a defense state or a parry state. When the first virtual object comes into contact with the second virtual object and the second virtual object is not in the second state, the virtual skill of the mirror interaction control successfully hits the second virtual object, so that the second virtual object is “brought” by the first virtual object to the location of the mirror virtual object.

When the foregoing two implementations are combined, the terminal can further determine the status of the second virtual object after determining that the first virtual object comes into contact with the second virtual object; and can control the first virtual object and the second virtual object to jointly move to the first location when the second virtual object is not in the second state. In other words, after the virtual skill corresponding to the mirror interaction control successfully hits the second virtual object, the terminal displays the movement control, and can control the first virtual object and the second virtual object to jointly move to the first location.

Operation 304 is described by using an example in which the first virtual object comes into contact with the second virtual object. In other possible implementations, the first virtual object does not come into contact with the second virtual object. The following describes a case in which the first virtual object does not come into contact with the second virtual object.

In a possible implementation, the terminal controls the first virtual object to move to the first location when the first virtual object does not come into contact with the second virtual object, and cancels the displaying of the mirror virtual object when the first virtual object and the mirror virtual object overlap.

In a possible implementation, the terminal controls the first virtual object to be maintained at a current location when the first virtual object does not come into contact with the second virtual object.

A penalty means is provided in the foregoing implementation. The terminal controls the first virtual object to be maintained at the current location when the first virtual object does not successfully come into contact with the second virtual object. Maintaining time is set by the technician according to an actual case. This is not limited in the embodiments of this application. When the maintaining time lasts, the first virtual object cannot move in the virtual scene.

305: The terminal controls, during the movement of the first virtual object in the first direction, the first virtual object to move to a second location in the virtual scene when the first virtual object comes into contact with the second virtual object, where the second virtual object is located between the first location and the second location.

In a possible implementation, the second location is associated with a location of the second virtual object in the virtual scene, a distance between the second location and the location of the second virtual object in the virtual scene is less than or equal to a second distance threshold. In other words, the second location is beside the second virtual object. The second distance threshold is set by the technician according to an actual case. This is not limited in the embodiments of this application. The second virtual object is located between the first location and the second location. When the first location is a left side of the virtual scene, the second location is a right side of the virtual scene. When the second virtual object is toward the left side of the virtual scene, the second location is the back of the second virtual object. For example, referring to FIG. 4, the first virtual object 401 is located on the back of the second virtual object 402.

In a possible implementation, the terminal determines, during the movement of the first virtual object in the first direction, a status of the second virtual object when the first virtual object comes into contact with the second virtual object. The terminal controls the first virtual object to move to the second location in the virtual scene when the second virtual object is not in a second state, where the second state is also referred to as a defense state or a parry state. When the second virtual object is in the second state, the first virtual object cannot successfully perform interaction with the second virtual object, that is, an attack by the first virtual object cannot take effect on the second virtual object. During the movement of the first virtual object to the second location, the second virtual object is in a state in which the second virtual object cannot move. When the first virtual object is toward the second virtual object and the second virtual object is toward the first virtual object, and when the first virtual object comes into contact with the second virtual object and the second virtual object is not in the second state, the terminal controls the first virtual object to move behind the second virtual object. When the second virtual object is in the second state, the terminal does not control the first virtual object to move to the second location, but interrupts the process in which the first virtual object moves in the first direction, and determines a final location of the first virtual object as a location at which the first virtual object comes into contact with the second virtual object.

In this implementation, the terminal can further determine the status of the second virtual object after determining that the first virtual object comes into contact with the second virtual object; and can control the first virtual object to move to the second location when the second virtual object is not in the second state. From a perspective of the user, that the first virtual object moves to the second location indicates that the virtual skill corresponding to the mirror interaction control is successfully triggered, and the efficiency of human-computer interaction is high. In addition, the second state provides a means for the second virtual object to counteract the first virtual object, to avoid a loss of balance of the game resulted from the virtual skill being excessively strong.

To describe the foregoing implementation more clearly, manners in which the terminal controls the first virtual object to move to the second location in the virtual scene are described below.

Manner 1: The terminal controls the first virtual object to pass over the second virtual object from the location at which the first virtual object comes into contact with the second virtual object, to arrive at the second location.

In this manner, the terminal controls the first virtual object to arrive at the second location with a specific trajectory, and the movement process of the first virtual object is smooth. For example, when the first virtual object comes into contact with the second virtual object and the second virtual object is not in the second state, the terminal generates a first trajectory by using the location at which the first virtual object comes into contact with the second virtual object as a start point, where the first trajectory is a trajectory that passes over the second virtual object from the start point, to arrive at the second location. The terminal controls the first virtual object to arrive at the second location along the first trajectory.

Manner 2: The terminal controls the first virtual object to directly pass through the second virtual object, to arrive at the second location.

In this manner, the terminal controls the first virtual object to move at a shortest distance, so that the first virtual object can arrive at the second location at a fast speed, and the efficiency of human-computer interaction is high.

Manner 3: The terminal controls the first virtual object to directly move from the location at which the first virtual object comes into contact with the second virtual object to the second location.

In this manner, the terminal controls the first virtual object to directly appear at the second location after the contact location disappears, so that the efficiency of location transformation of the first virtual object is the highest.

The terminal can control the first virtual object to move to the second location in any one of the foregoing manners. This is not limited in the embodiments of this application.

In a possible implementation, when the first virtual object is equipped with a virtual prop and the first virtual object comes into contact with the second virtual object, the terminal controls the first virtual object to perform interaction with the second virtual object by using the equipped virtual prop, that is, attacks the second virtual object by using the virtual prop. The terminal moves the first virtual object to the second location when the first virtual object successfully performs interaction with the second virtual object by using the virtual prop; and the terminal does not move the first virtual object to the second location when the first virtual object does not successfully perform interaction with the second virtual object by using the virtual prop, where whether the first virtual object can successfully perform interaction with the second virtual object by using the virtual prop depends on whether the second virtual object is in the second state. When the second virtual object is in the second state, the first virtual object cannot successfully perform interaction with the second virtual object by using the virtual prop; and when the second virtual object is not in the second state, the first virtual object can successfully perform interaction with the second virtual object by using the virtual prop.

306: The terminal controls the first virtual object to perform interaction with the second virtual object at the second location.

That the first virtual object performs interaction with the second virtual object at the second location means that the first virtual object attacks the second virtual object at the second location. A purpose of which the first virtual object performs interaction with the second virtual object at the second location is to change the location of the second virtual object. In a possible implementation, the purpose of the interaction further includes reducing a health value of the second virtual object.

In a possible implementation, when the first virtual object is equipped with a virtual prop, the terminal controls the first virtual object to perform interaction with the second virtual object by using the virtual prop at the second location, that is, controls the first virtual object to attack the second virtual object by using the virtual prop at the second location. For example, the terminal controls the first virtual object to wave the virtual prop to the second virtual object at the second location, or the terminal controls the first virtual object to attack the second virtual object in a form of “kicking” at the second location.

In this embodiment of this application, only an example in which the terminal may control the first virtual object to perform interaction with the second virtual object at the second location is used for description. In another embodiment, the terminal may not perform operation 306.

307: The terminal controls the first virtual object and the second virtual object to jointly move to the first location.

The first location is the location at which the terminal displays the mirror virtual object of the first virtual object, and that the second virtual object is controlled to move to the first location, means that the second virtual object is controlled to move to the location of the mirror virtual object.

In a possible implementation, the terminal generates a second trajectory based on a current location of the second virtual object and the first location, where a start point of the second trajectory is the current location of the second virtual object, and an end point of the second trajectory is the first location. The terminal controls the second virtual object to move to the first location along the second trajectory. A function for generating the trajectory based on the two locations is set by the technician according to an actual case. This is not limited in the embodiments of this application. When the second virtual object moves to the first location along the second trajectory, a geometric center of a model of the second virtual object is always located on the second trajectory.

308: The terminal controls the first virtual object to perform interaction with the second virtual object when the first virtual object and the mirror virtual object overlap and a distance between the second virtual object and the mirror virtual object meets a first distance condition.

That the first virtual object and the mirror virtual object overlap means that the model of the first virtual object and the model of the mirror virtual object overlap.

In a possible implementation, when the first virtual object and the mirror virtual object overlap and the distance between the second virtual object and the mirror virtual object is less than or equal to a first distance threshold, the terminal controls the first virtual object to perform interaction with the second virtual object, that is, controls the first virtual object to attack the second virtual object, for example, controls the first virtual object to attack the second virtual object by using the virtual prop.

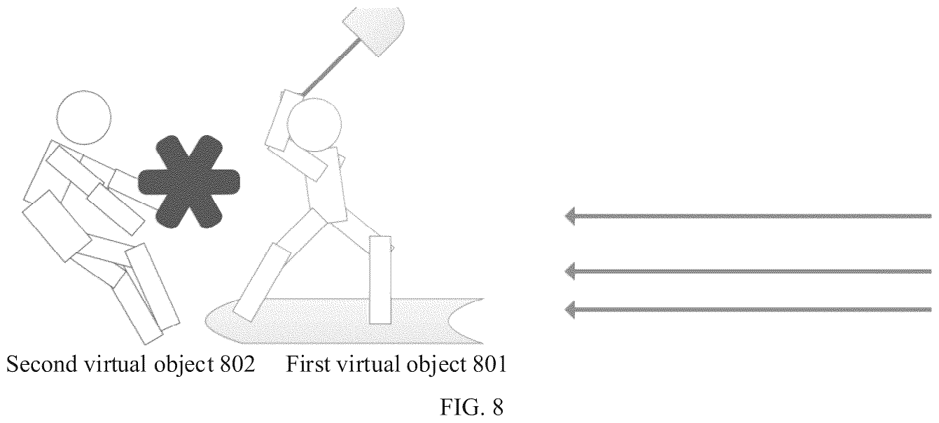

For example, referring to FIG. 8, when a first virtual object 801 and a mirror virtual object overlap and a distance between a second virtual object 802 and the mirror virtual object meets the first distance condition, the terminal controls the first virtual object 801 to perform interaction with the second virtual object 802.

In a possible implementation, the terminal controls the mirror virtual object and the first virtual object to simultaneously perform interaction with the second virtual object when the first virtual object and the mirror virtual object overlap and the distance between the second virtual object and the mirror virtual object is less than or equal to the first distance threshold.

In this implementation, the terminal can control the mirror virtual object and the first virtual object to simultaneously perform interaction with the second virtual object, that is, control the mirror virtual object and the first virtual object to simultaneously attack the second virtual object, thereby providing a richer attacking manner for the user, and improving the efficiency of human-computer interaction.

In a possible implementation, when the first virtual object and the mirror virtual object overlap and the distance between the second virtual object and the mirror virtual object meets the first distance condition, in addition to controlling the first virtual object to perform interaction with the second virtual object, the terminal can also separately control the mirror virtual object to directly perform interaction with the second virtual object. This is not limited in the embodiments of this application. In the embodiments of this application, an example in which the first virtual object performs interaction with the second virtual object is used for description.

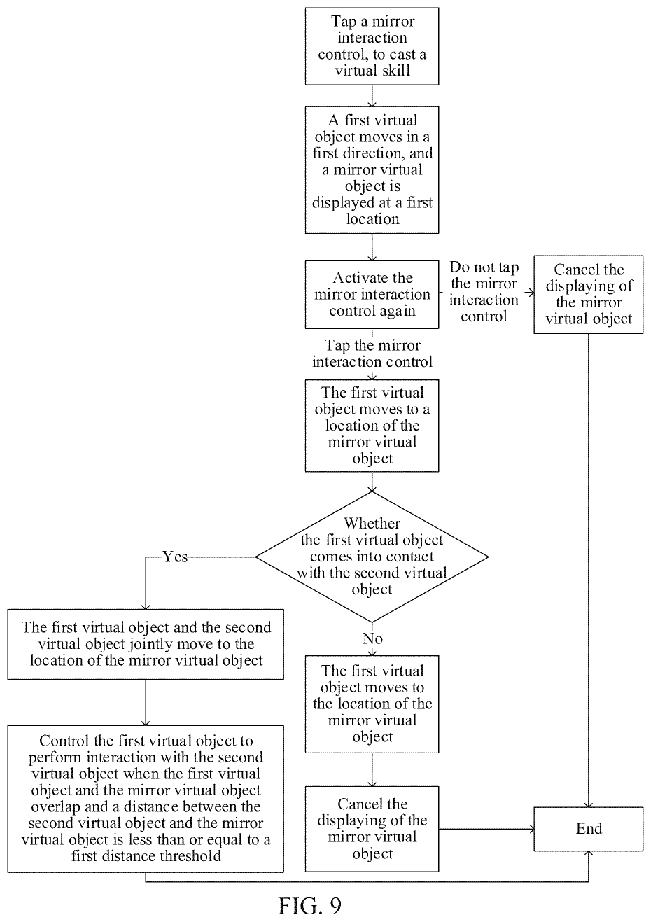

The foregoing implementation is described below with reference to FIG. 9. Referring to FIG. 9, a body is a first virtual object, a clone is a mirror virtual object of the first virtual object, and an enemy is a second virtual object. In response to a tap operation on a mirror interaction control, the terminal controls the body to cast a virtual skill in a virtual scene and move in a first direction, and displays the mirror virtual object of the first virtual object at a first location in the virtual scene. The user activates the mirror interaction control again, and the terminal controls the first virtual object to move to a location of the mirror virtual object in response to a tap operation on the mirror interaction control again. The first virtual object and the second virtual object are controlled to jointly move to the location of the mirror virtual object when the first virtual object comes into contact with the second virtual object. The first virtual object is controlled to perform interaction with the second virtual object when the first virtual object and the mirror virtual object overlap and the distance between the second virtual object and the mirror virtual object is less than or equal to the first distance threshold. When the first virtual object does not come into contact with the second virtual object, the first virtual object is controlled to move to the location of the mirror virtual object, and the displaying of the mirror virtual object is canceled. The terminal cancels the displaying of the mirror virtual object when the mirror interaction control is not taped for the second time.

In a possible implementation, after operation 308, the terminal can further perform the following operations 309 and 310, or perform the following operations 311 and 312, or perform the following operations 313 and 314, or perform the following operations 315 to 317. This is not limited in the embodiments of this application.

309: The terminal adjusts, when the first virtual object successfully performs interaction with the second virtual object, a location of the first virtual object to a third location, and controls the second virtual object to move to the third location, where the third location is a location at which the first virtual object comes into contact with the second virtual object.

That the first virtual object successfully performs interaction with the second virtual object means that an attack of the first virtual object successfully hits the second virtual object. That the attack of the first virtual object successfully hits the second virtual object means that fists and foot of the first virtual object or an equipped virtual prop comes into contact with the second virtual object. In a possible implementation, invisible collision detection boxes are bound to the fists or the foot of the first virtual object or the equipped virtual prop, an invisible collision detection is also bound to the second virtual object, and the terminal can determine, through the collision detection boxes, whether the attack of the first virtual object successfully hits the second virtual object. When the collision detection box corresponding to the first virtual object comes into contact with the collision detection box corresponding to the second virtual object, it is determined that the attack of the first virtual object successfully hits the second virtual object, that is, the first virtual object successfully performs interaction with the second virtual object. When the collision detection box corresponding to the first virtual object does not come into contact with the collision detection box corresponding to the second virtual object, it is determined that the attack of the first virtual object does not successfully hit the second virtual object, that is, the first virtual object does not successfully perform interaction with the second virtual object.

Through operation 309, when the first virtual object successfully performs interaction with the second virtual object, the terminal can move the first virtual object to the third location in the virtual scene, so that the user performs interaction with the second virtual object again based on the first virtual object.

310: The terminal displays a continuous interaction control, where the continuous interaction control is configured to control the first virtual object to perform interaction with the second virtual object.

The continuous interaction control is displayed when the first virtual object successfully performs interaction with the second virtual object, and may be considered as a “reward” for controlling the first virtual object to successfully perform interaction with the second virtual object. The continuous interaction control is configured to control the first virtual object to perform interaction with the second virtual object, that is, control the first virtual object to attack the second virtual object in the virtual scene.

In a possible implementation, after operation 310, the terminal can further execute the following solutions.

In a first solution, the terminal controls the first virtual object to move to a location of the second virtual object in response to a trigger operation on the continuous interaction control; and the terminal controls the first virtual object to perform interaction with the second virtual object when a distance between the first virtual object and the second virtual object meets a second distance condition.

A health value of the second virtual object decreases when the first virtual object successfully performs interaction with the second virtual object.

In this implementation, the continuous interaction control is triggered, so that the first virtual object can be controlled to automatically move to the location of the second virtual object, and can automatically perform interaction with the second virtual object when the distance between the first virtual object and the second virtual object meets the second distance condition. The interaction process only requires a single trigger by the user on the continuous interaction control, so that the efficiency of human-computer interaction is high.

For example, the terminal controls the first virtual object to move to the location of the second virtual object in response to a tap operation on the continuous interaction control. Because the second virtual object is “hit” by the mirror virtual object to the location of the first virtual object, the second virtual object is also in the movement process, and the location of the second virtual object continuously changes. In this case, that the first virtual object is controlled to move to the location of the second virtual object is also a process of continuously shortening the distance between the first virtual object and the second virtual object. When the distance between the first virtual object and the second virtual object is less than or equal to a second distance threshold, the terminal controls the first virtual object to perform interaction with the second virtual object, that is, controls the first virtual object to attack the second virtual object in the virtual scene. The second distance threshold is a maximum attack distance of the first virtual object, and the second distance threshold is set by the technician according to an actual case. This is not limited in the embodiments of this application.

In a second solution, the terminal displays a zoomed-in target virtual prop around the first virtual object in response to a trigger operation on the continuous interaction control, where the target virtual prop is a virtual prop equipped with the first virtual object; and the terminal controls, when the second virtual object comes into contact with the target virtual prop, the second virtual object to move in an upward direction of the first virtual object, and reduces a health value of the second virtual object.

In this implementation, the continuous interaction control is triggered, so that the terminal displays the zoomed-in target virtual prop around the first virtual object. The target virtual prop is the virtual prop equipped with the first virtual object. That the terminal zooms in and displays the target virtual prop means that a virtual obstacle is displayed in the virtual scene. When the second virtual object comes into contact with the target virtual prop, the terminal controls the second virtual object to change a movement direction, that is, move to from the third location to the upward direction of the first virtual object, to present a sense of “being kicked by the target virtual prop”. In this way, a manner in which the first virtual object performs interaction with the second virtual object is enriched, and the efficiency of human-computer interaction is improved.

For example, the terminal displays the zoomed-in target virtual prop around the first virtual object in response to a tap operation on the continuous interaction control, where surroundings of the first virtual object include a left side, a right side, or the location of the first virtual object; and the terminal controls, when the model of the second virtual object comes into contact with a model of the target virtual prop, the second virtual object to move in the upward direction of the first virtual object, and reduces the health value of the second virtual object.

311: The terminal determines, when the first virtual object successfully performs interaction with the second virtual object, a second direction based on a target portion of the second virtual object, where the second direction indicates a direction in which the second virtual object moves in the virtual scene, and the target portion is a portion with which the first virtual object successfully performs interaction.

The target portion of the second virtual object is the portion with which the first virtual object successfully performs interaction, or a hit portion of the second virtual object when the first virtual object attacks the second virtual object. In a possible implementation, invisible collision detection boxes are respectively bound to a plurality of portions of the second virtual object. When the first virtual object successfully performs interaction with the second virtual object, the terminal determines a target collision detection box on the second virtual object with which the first virtual object comes into contact during interaction, where a portion bound to the target collision detection box is the target portion of the second virtual object.

In a possible implementation, the terminal determines a downward direction of the mirror virtual object as the second direction when the target portion is a head of the second virtual object.

In this implementation, when the second virtual object needs to move in the downward direction of the mirror virtual object, the user controls the mirror virtual object to perform interaction with the head of the second virtual object, so that the efficiency of human-computer interaction is high.

In a possible implementation, the terminal determines a direction in which the second virtual object moves to the first virtual object as the second direction when the target portion is a torso of the second virtual object.

In this implementation, when the second virtual object needs to move in the direction in which the first virtual object is located, the user controls the mirror virtual object to perform interaction with the torso of the second virtual object, so that the efficiency of human-computer interaction is high.

In a possible implementation, the terminal determines an upward direction of the mirror virtual object as the second direction when the target portion is a foot of the second virtual object.

In this implementation, when the second virtual object needs to move in the upward direction of the mirror virtual object, the user controls the mirror virtual object to perform interaction with the foot of the second virtual object, so that the efficiency of human-computer interaction is high.

The parts given in the foregoing three implementations are merely examples. In other possible implementations, the technician may alternatively subdivide the second virtual object into more portions and set a movement direction for each portion. This is not limited in the embodiments of this application.

Through operation 311, the user can control the mirror virtual object to perform interaction with different portions of the second virtual object, to achieve the purpose of controlling the second virtual object to move in different directions, and the user can select different movement directions according to an actual case, thereby completing different interaction combinations, providing rich selections for the user, and improving game experience of the user.

312: The terminal controls the second virtual object to move in the second direction in the virtual scene.

313: The terminal controls the first virtual object to enter a first state when the first virtual object successfully performs interaction with the second virtual object.

The first state may also be referred to as a counteract state or a counter-attack state. When the first virtual object is in the first state, the first virtual object can automatically perform interaction with the second virtual object when the second virtual object performs interaction with the first virtual object, that is, the first virtual object in the first state can automatically counter-attack when the second virtual object attacks the first virtual object. The first state has specified duration, and the duration is set by the technician according to an actual case.

314: The terminal controls, within duration of the first state, the first virtual object to automatically perform interaction with the second virtual object when the second virtual object successfully performs interaction with the first virtual object.

In a possible implementation, the terminal controls, within the duration of the first state, the first virtual object to automatically attack the second virtual object in response to that an attack of the second virtual object hits the first virtual object.

315: The terminal adjusts, when the first virtual object successfully performs interaction with the second virtual object, a location of the first virtual object to a third location, and displays a location exchange control, where the third location is a location at which the first virtual object comes into contact with the second virtual object.

A function of the location exchange control is to exchange locations of the first virtual object and the mirror virtual object. A display location of the location exchange control is set by the technician according to an actual case. This is not limited in the embodiments of this application.

316: The terminal exchanges locations of the first virtual object and the mirror virtual object in the virtual scene again in response to a trigger operation on the location exchange control.

In a possible implementation, the terminal exchanges the locations of the first virtual object and the mirror virtual object in the virtual scene in response to a tap operation on the location exchange control.

317: The terminal controls the first virtual object to perform interaction with the second virtual object in response to a trigger operation on the mirror interaction control again.

In a possible implementation, the terminal controls the first virtual object to perform interaction with the second virtual object in response to a tap operation on the mirror interaction control again, that is, controls the first virtual object to attack the second virtual object, for example, controls the first virtual object to attack the second virtual object by using the virtual prop.

After the mirror interaction control is taped again, the first virtual object directly performs an action of performing interaction with the second virtual object. However, performing the action does not indicate that the first virtual object can successfully perform interaction with the second virtual object, and there may be a case that the interaction fails. For example, if that the first virtual object performs interaction with the second virtual object means that the first virtual object attacks the second virtual object in the virtual scene, after the mirror interaction control is taped, the first virtual object performs an attack action, for example, waving the equipped virtual prop. However, the attack action performed by the first virtual object may hit the second virtual object or may not hit the second virtual object. The case is caused by two reasons. First, there is a limitation on a distance within which the first virtual object performs interaction. Second, the second virtual object is moved to the first location, and the second virtual object is in a moving state. The premise for the first virtual object to successfully perform interaction with the second virtual object is that a trigger occasion of the mirror interaction control is within a target time range. The target time range is determined by the terminal based on parameters such as a movement speed of the second virtual object, size information of the second virtual object, and the interaction distance of the first virtual object. From a perspective of the user, the premise of intending to control the first virtual object to successfully perform interaction with the second virtual object is that an occasion at which the mirror interaction control is taped again is correct, which can be implemented through a plurality of times of training of the user.

In a possible implementation, in addition to content described in operation 317, the terminal can further perform the following operations after the mirror interaction control is triggered again.

In a first solution, the terminal controls the mirror virtual object to move to the location of the first virtual object in response to a trigger operation on the mirror interaction control again; and the terminal reduces a health value of the second virtual object when the mirror virtual object comes into contact with the second virtual object. Certainly, in the process in which the terminal controls the mirror virtual object to move to the location of the first virtual object, the terminal may simultaneously control the first virtual object to perform interaction with the second virtual object. The trigger operation is a tap operation.

In this implementation, by controlling the mirror virtual object to move to the location of the first virtual object, the terminal provides another manner in which the first virtual object performs interaction with the second virtual object, that is, contact with the mirror virtual object reduces the health value of the second virtual object, thereby enriching user selections, and improving the efficiency of human-computer interaction.

In a second solution, the terminal cancels the displaying of the mirror virtual object when the first virtual object and the mirror virtual object overlap.

In a possible implementation, after operation 317, the terminal can further perform the following operations.

In a first solution, the terminal controls the second virtual object to move to a current location of the mirror virtual object when the first virtual object successfully performs interaction with the second virtual object; the terminal exchanges the locations of the first virtual object and the mirror virtual object in the virtual scene again in response to a trigger operation on the location exchange control again; and the terminal controls the first virtual object to perform interaction with the second virtual object again in response to a trigger operation on the mirror interaction control again. The trigger operation is a tap operation.

In this implementation, the location exchange control is also provided with a function of secondary triggering. Through secondary triggering of the location exchange control, the locations of the first virtual object and the mirror virtual object can be exchanged again, so that interaction can be performed with the second virtual object again based on the first virtual object.

The foregoing operations 301 to 317 are described by using an example in which the terminal is the execution entity. In other possible implementations, the server may alternatively perform data processing operations in the foregoing operations 301 to 317, and the terminal may display data processing results. This is not limited in the embodiments of this application.

All the foregoing exemplary technical solutions may be arbitrarily combined to form an exemplary embodiment of this application, and details are not described herein again.

Through the technical solutions provided in the embodiments of this application, a first virtual object and a second virtual object are displayed in a virtual scene, and a mirror interaction control can be triggered to control the first virtual object to move in a first direction, and display a mirror virtual object of the first virtual object in the virtual scene; during the movement of the first virtual object, the first virtual object is controlled to move to a location of the mirror virtual object in response to a trigger operation on the mirror interaction control again; the first virtual object and the second virtual object are controlled to jointly move to the location of the mirror virtual object when the first virtual object comes into contact with the second virtual object; and the first virtual object is controlled to perform interaction with the second virtual object when the first virtual object and the mirror virtual object overlap. Through the setting of the mirror virtual object, a manner of interaction between the first virtual object and the second virtual object is enriched, so that a user can effectively perform interaction with the second virtual object by using the mirror virtual object, thereby improving efficiency of human-computer interaction.

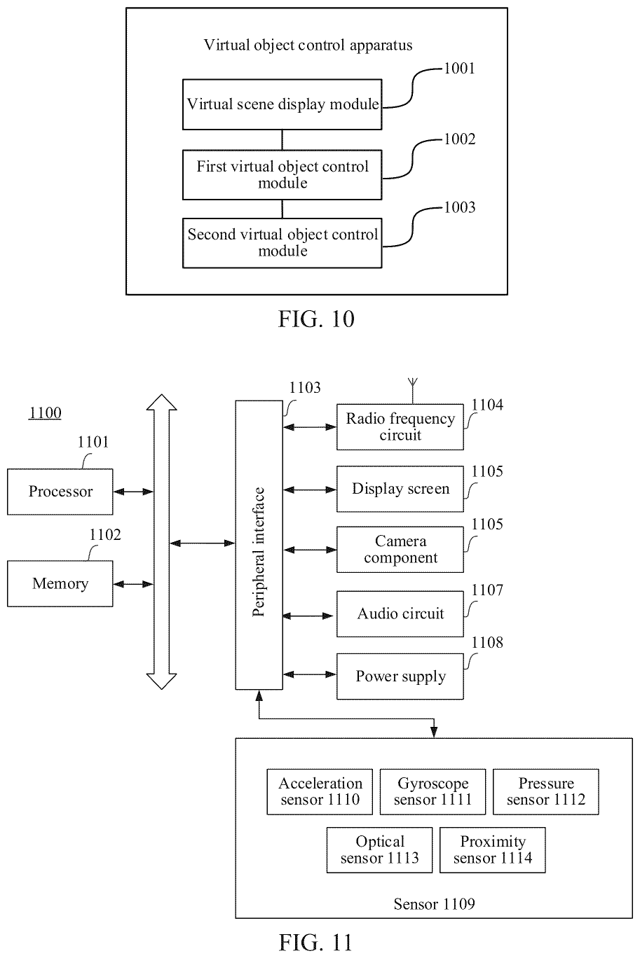

FIG. 10 is a schematic structural diagram of a virtual object control apparatus according to an embodiment of this application. The apparatus is disposed in a computer device, for example, the computer device is a terminal. Referring to FIG. 10, the apparatus includes a virtual scene display module 1001, a first virtual object control module 1002, and a second virtual object control module 1003.

The virtual scene display module 1001 is configured to display a virtual scene, a first virtual object and a second virtual object being displayed in the virtual scene, the first virtual object being a virtual object controlled by a terminal, and the second virtual object and the first virtual object belonging to different camps.

The first virtual object control module 1002 is configured to control, in response to a trigger operation on a mirror interaction control, the first virtual object to move in a first direction, and display a mirror virtual object of the first virtual object at a first location in the virtual scene,

the first virtual object control module 1002 being further configured to control, during the movement of the first virtual object in the first direction, the first virtual object to move to the first location in response to a trigger operation on the mirror interaction control again.

The second virtual object control module 1003 is configured to control the first virtual object and the second virtual object to jointly move to the first location when the first virtual object comes into contact with the second virtual object,

the first virtual object control module 1002 being further configured to control the first virtual object to perform interaction with the second virtual object when the first virtual object and the mirror virtual object overlap.

In a possible implementation, the first virtual object control module 1002 is configured to control the first virtual object to move to the first location when the first virtual object does not come into contact with the second virtual object; and cancel the displaying of the mirror virtual object when the first virtual object and the mirror virtual object overlap.

In a possible implementation, the first virtual object control module 1002 is configured to control the first virtual object to perform interaction with the second virtual object when the first virtual object and the mirror virtual object overlap and a distance between the second virtual object and the mirror virtual object meets a first distance condition.

In a possible implementation, the first virtual object control module 1002 is configured to control the mirror virtual object and the first virtual object to simultaneously perform interaction with the second virtual object when the first virtual object and the mirror virtual object overlap and the distance between the second virtual object and the mirror virtual object is less than or equal to a first distance threshold.

In a possible implementation, the second virtual object control module 1003 is further configured to determine, when the first virtual object successfully performs interaction with the second virtual object, a second direction based on a target portion of the second virtual object, where the second direction indicates a direction in which the second virtual object moves in the virtual scene, and the target portion of the second virtual object is a portion with which the first virtual object successfully performs interaction; and control the second virtual object to move in the second direction in the virtual scene.

In a possible implementation, the second virtual object control module 1003 is further configured to perform at least one of the following:

determining a downward direction of the mirror virtual object as the second direction when the target portion is a head of the second virtual object;

determining a direction in which the second virtual object moves to the first virtual object as the second direction when the target portion is a torso of the second virtual object; or

determining an upward direction of the mirror virtual object as the second direction when the target portion is a foot of the second virtual object.

In a possible implementation, the first virtual object control module 1002 is further configured to control the first virtual object to enter a first state when the first virtual object successfully performs interaction with the second virtual object; and control, within duration of the first state, the first virtual object to automatically perform interaction with the second virtual object when the second virtual object successfully performs interaction with the first virtual object.

In a possible implementation, the second virtual object control module 1003 is configured to control the first virtual object to move to a second location in the virtual scene when the first virtual object comes into contact with the second virtual object, where the second virtual object is located between the first location and the second location; and control the first virtual object and the second virtual object to jointly move to the first location.

In a possible implementation, the second virtual object control module 1003 is configured to control the first virtual object to perform interaction with the second virtual object at the second location.

In a possible implementation, the first virtual object control module 1002 is further configured to adjust, when the first virtual object successfully performs interaction with the second virtual object, a location of the first virtual object to a third location, and control the second virtual object to move to the third location in the virtual scene, where the third location is a location at which the first virtual object comes into contact with the second virtual object; and

the apparatus further includes:

a continuous interaction control display module, configured to display a continuous interaction control, where the continuous interaction control is configured to control the first virtual object to perform interaction with the second virtual object.

In a possible implementation, the first virtual object control module 1002 is further configured to perform at least one of the following:

controlling the first virtual object to move to a location of the second virtual object in response to a trigger operation on the continuous interaction control; and controlling the first virtual object to perform interaction with the second virtual object when a distance between the first virtual object and the second virtual object meets a second distance condition; or

displaying a zoomed-in target virtual prop around the first virtual object in response to a trigger operation on the continuous interaction control, where the target virtual prop is a virtual prop equipped with the first virtual object; and controlling, when the second virtual object comes into contact with the target virtual prop, the second virtual object to move in an upward direction of the first virtual object, and reducing a health value of the second virtual object.

In a possible implementation, the first virtual object control module 1002 is further configured to adjust, when the first virtual object successfully performs interaction with the second virtual object, a location of the first virtual object to a third location, and display a location exchange control, where the third location is a location at which the first virtual object comes into contact with the second virtual object; exchange the locations of the first virtual object and the mirror virtual object in the virtual scene again in response to a trigger operation on the location exchange control again; and control the first virtual object to perform interaction with the second virtual object in response to a trigger operation on the mirror interaction control again.

In a possible implementation, a mirror virtual object control module is further configured to control the mirror virtual object to move to the location of the first virtual object; and reduce a health value of the second virtual object when the mirror virtual object comes into contact with the second virtual object.

In a possible implementation, the first virtual object control module 1002 is further configured to control the second virtual object to move to a current location of the mirror virtual object when the first virtual object successfully performs interaction with the second virtual object; exchange the locations of the first virtual object and the mirror virtual object in the virtual scene again in response to a trigger operation on the location exchange control again; and control the first virtual object to perform interaction with the second virtual object again in response to a trigger operation on the mirror interaction control again.

In a possible implementation, the first virtual object control module 1002 is further configured to maintain the first virtual object at a current location when the first virtual object does not successfully perform interaction with the second virtual object.

In a possible implementation, the mirror virtual object control module is further configured to cancel the displaying of the mirror virtual object when the first virtual object comes into contact with the second virtual object and the second virtual object is in a second state.

In a possible implementation, the mirror virtual object control module is further configured to cancel the displaying of the mirror virtual object in response to that a trigger operation performed on the mirror interaction control is not detected within target duration.

The virtual object control apparatus provided in the foregoing embodiments is illustrated with an example of division of the foregoing functional modules when virtual objects are controlled. In actual application, the functions may be allocated to and completed by different functional modules according to requirements, that is, the internal structure of the computer device is divided into different functional modules, to implement all or some of the functions described above. In addition, the virtual object control apparatus and the virtual object control method provided in the foregoing embodiments belong to the same concept. For a specific implementation process, refer to the method embodiment, and details are not described herein again.

Through the technical solutions provided in the embodiments of this application, a first virtual object and a second virtual object are displayed in a virtual scene, and a mirror interaction control can be triggered to control the first virtual object to move in a first direction, and display a mirror virtual object of the first virtual object in the virtual scene; during the movement of the first virtual object, the first virtual object is controlled to move to a location of the mirror virtual object in response to a trigger operation on the mirror interaction control again; the first virtual object and the second virtual object are controlled to jointly move to the location of the mirror virtual object when the first virtual object comes into contact with the second virtual object; and the first virtual object is controlled to perform interaction with the second virtual object when the first virtual object and the mirror virtual object overlap. Through the setting of the mirror virtual object, a manner of interaction between the first virtual object and the second virtual object is enriched, so that a user can effectively perform interaction with the second virtual object by using the mirror virtual object, thereby improving efficiency of human-computer interaction.

An embodiment of this application provides a computer device, including one or more processors and one or more memories, the one or more memories having at least one computer program stored therein, the at least one computer program being loaded and executed by the one or more processors to implement the foregoing virtual object control method.

The computer device may be a terminal or a server. A structure of the terminal is first described below.

FIG. 11 is a schematic structural diagram of a terminal according to an embodiment of this application. A terminal 1100 may be a smartphone, a tablet computer, a notebook computer, or a desktop computer. The terminal 1100 may also be referred to as another name such as user equipment, a portable terminal, a laptop terminal, or a desktop terminal.

Generally, the terminal 1100 includes one or more processors 1101 and one or more memories 1102.

The processor 1101 may include one or more processing cores. For example, the processor may be a 4-core processor or an 8-core processor. The processor 1101 may be implemented in at least one hardware form of digital signal processor (DSP), a field-programmable gate array (FPGA), and a programmable logic array (PLA). The processor 1101 further includes a main processor and a coprocessor. The main processor is configured to process data in an active state, also referred to as a central processing unit (CPU). The coprocessor is a low-power consumption processor configured to process data in a standby state. In a possible implementation, the processor 1101 may be integrated with a graphics processing unit (GPU). The GPU is configured to render and draw content that needs to be displayed on a display. In some embodiments, the processor 1101 may further include an AI processor. The AI processor is configured to process computing operations related to ML.

The memory 1102 may include one or more computer-readable storage media. The computer-readable storage medium may be non-transient. The memory 1102 may further include a high-speed random access memory and a non-volatile memory, for example, one or more disk storage devices or flash storage devices. In a possible implementation, a non-transitory computer-readable storage medium in the memory 1102 is configured to store at least one computer program, the at least one computer program being configured to be executed by the processor 1101 to implement the virtual object control method provided in the method embodiments of this application.

In a possible implementation, the terminal 1100 may include a peripheral interface 1103 and at least one peripheral. The processor 1101, the memory 1102, and the peripheral interface 1103 may be connected by a bus or a signal line. Each peripheral may be connected to the peripheral interface 1103 by using a bus, a signal cable, or a circuit board. Specifically, the peripheral includes: at least one of a radio frequency (RF) circuit 1104, a display screen 1105, a camera component 1106, an audio circuit 1107, and a power supply 1108.

The peripheral interface 1103 may be configured to connect the at least one peripheral related to input/output (I/O) to the processor 1101 and the memory 1102. In a possible implementation, the processor 1101, the memory 1102, and the peripheral interface 1103 are integrated on the same chip or the same circuit board. In some other embodiments, any or both of the processor 1101, the memory 1102, and the peripheral interface 1103 may be implemented on an independent chip or circuit board, which is not limited in this embodiment.

The RF circuit 1104 is configured to receive and transmit an RF signal, also referred to as an electromagnetic signal. The RF circuit 1104 communicates with a communication network and other communication devices through the electromagnetic signal. The RF circuit 1104 converts an electric signal into an electromagnetic signal for transmission, or converts a received electromagnetic signal into an electric signal. In one embodiment, the RF circuit 1104 includes: an antenna system, an RF transceiver, one or more amplifiers, a tuner, an oscillator, a digital signal processor, a codec chip set, a subscriber identity module card, and the like.

The display screen 1105 is configured to display a user interface (UI). The UI may include a graph, a text, an icon, a video, and any combination thereof. When the display screen 1105 is a touch display screen, the display screen 1105 is further capable of collecting touch signals on or above a surface of the display screen 1105. The touch signal may be used as a control signal to be inputted to the processor 1101 for processing. In this case, the display screen 1105 may be further configured to provide a virtual button and/or a virtual keyboard that are/is also referred to as a soft button and/or a soft keyboard.

The camera assembly 1106 is configured to capture an image or a video. In one embodiment, the camera component 1106 includes a front-facing camera and a rear-facing camera. Generally, the front-facing camera is disposed on the front panel of the terminal, and the rear-facing camera is disposed on a back surface of the terminal.

The audio circuit 1107 may include a microphone and a speaker. The microphone is configured to acquire sound waves of users and surroundings, and convert the sound waves into electrical signals and input the signals to the processor 1101 for processing, or input the signals to the RF circuit 1104 to implement voice communication.

The power supply 1108 is configured to supply power to components in the terminal 1100. The power supply 1108 may be an alternating current, a direct current, a primary battery, or a rechargeable battery.

In a possible implementation, the terminal 1100 further includes one or more sensors 1109. The one or more sensors 1109 include, but are not limited to: an acceleration sensor 1110, a gyroscope sensor 1111, a pressure sensor 1112, an optical sensor 1113, and a proximity sensor 1114.

The acceleration sensor 1110 may detect acceleration on three coordinate axes of a coordinate system established by the terminal 1100.

The gyroscope sensor 1111 may detect a body direction and a rotation angle of the terminal 1100, and may collect a 3D action of the user on the terminal 1100 together with the acceleration sensor 1110.

The pressure sensor 1112 may be disposed on a side frame of the terminal 1100 and/or a lower layer of the display screen 1105. When the pressure sensor 1112 is disposed at the side frame of the terminal 1100, a holding signal of the user on the terminal 1100 may be detected, and left/right hand identification or a quick action may be performed by the processor 1101 according to the holding signal collected by the pressure sensor 1112. When the pressure sensor 1112 is disposed on the low layer of the display screen 1105, the processor 1101 controls, according to a pressure operation of the user on the display screen 1105, an operable control on the UI.

The optical sensor 1113 is configured to collect ambient light intensity. In an embodiment, the processor 1101 may control display brightness of the display screen 1105 according to the ambient light intensity collected by the optical sensor 1113.

The proximity sensor 1114 is configured to collect a distance between the user and a front face of the terminal 1100.

A person skilled in the art may understand that the structure shown in FIG. 11 does not constitute a limitation to the terminal 1100, and the terminal may include more components or fewer components than those shown in the figure, or some components may be combined, or a different component deployment may be used

The foregoing computer device may alternatively be implemented as a server. A structure of the server is described below.

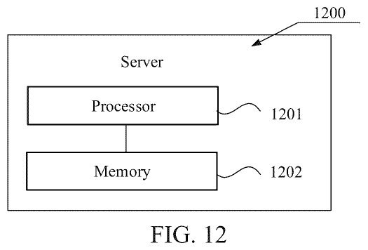

FIG. 12 is a schematic structural diagram of a server according to an embodiment of this application. A server 1200 may vary greatly due to different configurations or performance, and may include one or more CPUs 1201 and one or more memories 1202. The one or more memories 1202 store at least one computer program, the at least one computer program being loaded and executed by the one or more processors 1201 to implement the methods provided in the foregoing method embodiments. Certainly, the server 1200 may also have a wired or wireless network interface, a keyboard, an input/output interface and other components to facilitate input/output. The server 1200 may also include other components for implementing device functions. Details are not described herein again.

In an exemplary embodiment, a computer-readable storage medium, for example, a memory including a computer program, is further provided. The computer program may be executed by a processor to implement the virtual object control method in the foregoing embodiments. For example, the computer-readable storage medium may be a read-only memory (ROM), a random access memory (RAM), a compact disc ROM (CD-ROM), a magnetic tape, a floppy disk, an optical data storage device, or the like.

In an exemplary embodiment, a computer program product or a computer program is further provided, including program code, the program code being stored in a computer-readable storage medium, a processor of a computer device reading the program code from the computer-readable storage medium, and the processor executing the program code, to cause the computer device to perform the virtual object control method.

In some embodiments, the computer program involved in this embodiment of this application may be deployed on one computer device for execution, or deployed on a plurality of computer devices at one location, or executed on a plurality of computer devices distributed at a plurality of locations and interconnected through a communication network. The plurality of computer devices distributed at the plurality of locations and interconnected through the communication network may form a blockchain system.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual object control method performed by a computer device, the method comprising:
displaying a first virtual object and a second virtual object in a virtual scene, the second virtual object and the first virtual object belonging to different camps;
in response to a first trigger operation on a mirror interaction control associated with the first virtual object, controlling the first virtual object to move in a first direction, and displaying a mirror virtual object of the first virtual object at a first location in the virtual scene based on, but different from, a contact location at which the first virtual object comes into contact with the second virtual object;
during the movement of the first virtual object in the first direction, controlling the first virtual object to move to the first location in response to a second trigger operation on the mirror interaction control;
controlling the first virtual object and the second virtual object to jointly move to the first location after the first virtual object comes into contact with the second virtual object; and
controlling the first virtual object to perform interaction with the second virtual object after the first virtual object and the mirror virtual object overlap.

2. The method according to claim 1, wherein after the controlling the first virtual object to move to the first location in response to a second trigger operation on the mirror interaction control, the method further comprises:
controlling the first virtual object to move to the first location when the first virtual object does not come into contact with the second virtual object; and
canceling the displaying of the mirror virtual object when the first virtual object and the mirror virtual object overlap.

3. The method according to claim 1, wherein the controlling the first virtual object to perform interaction with the second virtual object after the first virtual object and the mirror virtual object overlap comprises:
controlling the mirror virtual object and the first virtual object to simultaneously perform interaction with the second virtual object when the first virtual object and the mirror virtual object overlap and the distance between the second virtual object and the mirror virtual object is less than or equal to a first distance threshold.

4. The method according to claim 1, wherein the method further comprises:
after the first virtual object successfully performs interaction with the second virtual object, determining a second direction based on a target portion of the second virtual object, wherein the second direction indicates a direction in which the second virtual object moves in the virtual scene, and the target portion is a portion with which the first virtual object successfully performs interaction; and
controlling the second virtual object to move in the second direction in the virtual scene.

5. The method according to claim 1, wherein the method further comprises:
controlling the first virtual object to enter a first state when the first virtual object successfully performs interaction with the second virtual object; and
controlling, within duration of the first state, the first virtual object to automatically perform interaction with the second virtual object when the second virtual object successfully performs interaction with the first virtual object.

6. The method according to claim 1, wherein the controlling the first virtual object and the second virtual object to jointly move to the first location after the first virtual object comes into contact with the second virtual object comprises:
when the first virtual object comes into contact with the second virtual object, controlling the first virtual object to move to a second location in the virtual scene, and controlling the first virtual object and the second virtual object to jointly move to the first location, wherein the second virtual object is located between the first location and the second location.

7. The method according to claim 1, wherein the method further comprises:
after the first virtual object successfully performs interaction with the second virtual object, controlling the second virtual object to move to a third location, wherein the third location is a new location at which the first virtual object comes into contact with the second virtual object;
controlling the first virtual object to perform interaction with the second virtual object when a distance between the first virtual object and the second virtual object meets a second distance condition;
displaying a zoomed-in target virtual prop around the first virtual object in, wherein the target virtual prop is a virtual prop equipped with the first virtual object; and
when the second virtual object comes into contact with the target virtual prop, controlling the second virtual object to move in an upward direction of the first virtual object, and reducing a health value of the second virtual object.

8. The method according to claim 1, wherein the method further comprises:
exchanging locations of the first virtual object and the mirror virtual object in response to a trigger operation on a location exchange control; and
controlling the first virtual object to perform interaction with the second virtual object in response to a third trigger operation on the mirror interaction control.

9. The method according to claim 8, wherein the method further comprises:
controlling the mirror virtual object to move to the location of the first virtual object; and
reducing a health value of the second virtual object when the mirror virtual object comes into contact with the second virtual object.

10. The method according to claim 1, wherein the method further comprises:
maintaining the first virtual object at a current location when the first virtual object does not successfully perform interaction with the second virtual object.

11. The method according to claim 1, wherein after the displaying a mirror virtual object of the first virtual object at a first location in the virtual scene, the method further comprises:
canceling the display of the mirror virtual object when the first virtual object comes into contact with the second virtual object and the second virtual object is in a second state.

12. The method according to claim 1, wherein after the displaying a mirror virtual object of the first virtual object at a first location in the virtual scene, the method further comprises:
canceling the display of the mirror virtual object when a trigger operation performed on the mirror interaction control is not detected within target duration.

13. A computer device, comprising one or more processors and one or more memories, the one or more memories having at least one computer program stored therein, the at least one computer program, when executed by the one or more processors, causing the computer device to implement a virtual object control method including:
displaying a first virtual object and a second virtual object in a virtual scene, the second virtual object and the first virtual object belonging to different camps;
in response to a first trigger operation on a mirror interaction control associated with the first virtual object, controlling the first virtual object to move in a first direction, and displaying a mirror virtual object of the first virtual object at a first location in the virtual scene based on, but different from, a contact location at which the first virtual object comes into contact with the second virtual object;
during the movement of the first virtual object in the first direction, controlling the first virtual object to move to the first location in response to a second trigger operation on the mirror interaction control;
controlling the first virtual object and the second virtual object to jointly move to the first location after the first virtual object comes into contact with the second virtual object; and
controlling the first virtual object to perform interaction with the second virtual object after the first virtual object and the mirror virtual object overlap.

14. The computer device according to claim 13, wherein after the controlling the first virtual object to move to the first location in response to a second trigger operation on the mirror interaction control, the method further comprises:
controlling the first virtual object to move to the first location when the first virtual object does not come into contact with the second virtual object; and
canceling the displaying of the mirror virtual object when the first virtual object and the mirror virtual object overlap.

15. The computer device according to claim 13, wherein the controlling the first virtual object to perform interaction with the second virtual object after the first virtual object and the mirror virtual object overlap comprises:
controlling the mirror virtual object and the first virtual object to simultaneously perform interaction with the second virtual object when the first virtual object and the mirror virtual object overlap and the distance between the second virtual object and the mirror virtual object is less than or equal to a first distance threshold.

16. The computer device according to claim 13, wherein the method further comprises:
after the first virtual object successfully performs interaction with the second virtual object, determining a second direction based on a target portion of the second virtual object, wherein the second direction indicates a direction in which the second virtual object moves in the virtual scene, and the target portion is a portion with which the first virtual object successfully performs interaction; and
controlling the second virtual object to move in the second direction in the virtual scene.

17. The computer device according to claim 13, wherein the method further comprises:
controlling the first virtual object to enter a first state when the first virtual object successfully performs interaction with the second virtual object; and
controlling, within duration of the first state, the first virtual object to automatically perform interaction with the second virtual object when the second virtual object successfully performs interaction with the first virtual object.

18. The computer device according to claim 13, wherein the method further comprises:
after the first virtual object successfully performs interaction with the second virtual object, controlling the second virtual object to move to a third location, wherein the third location is a new location at which the first virtual object comes into contact with the second virtual object;
controlling the first virtual object to perform interaction with the second virtual object when a distance between the first virtual object and the second virtual object meets a second distance condition;
displaying a zoomed-in target virtual prop around the first virtual object in, wherein the target virtual prop is a virtual prop equipped with the first virtual object; and
when the second virtual object comes into contact with the target virtual prop, controlling the second virtual object to move in an upward direction of the first virtual object, and reducing a health value of the second virtual object.

19. The computer device according to claim 13, wherein the method further comprises:
exchanging locations of the first virtual object and the mirror virtual object in response to a trigger operation on a location exchange control; and
controlling the first virtual object to perform interaction with the second virtual object in response to a third trigger operation on the mirror interaction control.

20. A non-transitory computer-readable storage medium, having at least one computer program stored therein, the computer program, when executed by a processor of a computer device, causing the computer device to implement a virtual object control method including:
displaying a first virtual object and a second virtual object in a virtual scene, the second virtual object and the first virtual object belonging to different camps;
in response to a first trigger operation on a mirror interaction control associated with the first virtual object, controlling the first virtual object to move in a first direction, and displaying a mirror virtual object of the first virtual object at a first location in the virtual scene based on, but different from, a contact location at which the first virtual object comes into contact with the second virtual object;
during the movement of the first virtual object in the first direction, controlling the first virtual object to move to the first location in response to a second trigger operation on the mirror interaction control;
controlling the first virtual object and the second virtual object to jointly move to the first location after the first virtual object comes into contact with the second virtual object; and
controlling the first virtual object to perform interaction with the second virtual object after the first virtual object and the mirror virtual object overlap.
